(19) United States
(12) Patent Application Publication
(10) Pub. No.: US 2005/0098415 A1
(43) Pub. Date: May 12, 2005

(54) Safety connector with power breaker

(76) Inventor: Han-Ming Lee, Taipei City (TW)

Correspondence Address: Lee, Han-Ming, P.O. BOX 7-288, TAIPEI, TW

(21) Appl. No.: 10/701,981

(22) Filed: Nov. 6, 2003

(51) Int. Cl. H01R 24/00

(52) U.S. Cl. 200/51.11

(57) ABSTRACT

The present invention discloses a safety connector with power breaker, comprising a base, a socket, a terminal plate, a conductive board, a switch, and an electric wire, wherein a concave track each on both sides of the groove in the base and an arc opening for forming a circumference with the semicircular opening at the section of the two longitudinal boards of the socket, and a fixed switch being used to balance the support axle to facilitate the control over the switching function. This invention also comprises two aslant wings coupled to both ends of the conductive board for sliding and embedding into the square groove at the bottom of the two longitudinal boards in order to fix the board into a position, such that the conductive board will bounce off due to the high temperature coefficient to instantly disconnect the power and demonstrate the function of automatic power breaker.

### BACKGROUND OF THE INVENTION

Electric appliances are designed for households or industries in this “era of electricity”. Our daily life all rely greatly on plugs to provide power/electricity. Plugs will need sockets to take effects and form a dual entity, and also create safety problems inevitably when use. Conventionally, plugs are assembled in two ways, that is, either locking the upper and the lower plug plates with the cover, or that the wires and the plug itself are cast into an embodiment. In the former design wherein the plug plates are locked up by the cover above and beneath, thus the pole plates at the two ends are readily loosen and dangling, which may cause accidents due to poor electric contact. Although the latter design involves casting a plug with a die and therefore the use of the plug is stable and effective, the latter design has two drawbacks. Firstly, the plug entity is not equipped with any device to shutdown power. Therefore, when the plug steel plates are been plugged in and out of socket, which may generate sparks. Secondly, the plug plates are normally exposed in the air at certain humidity and generate static electricity when use; besides, if the wires are not long enough, the extension socket will be used and the danger of electric shocks will increase when plug in and out of extension socket. Hence, there should be rooms for improvement in the structure of the conventional plugs.

### SUMMARY OF THE INVENTION

The primary objective of the present invention is to provide a safety connector with power breaker, comprising a base, a socket, a terminal plate, a conductive board, a switch, and an electric wire, wherein the conductive board will bounce off due to the high temperature coefficient to instantly disconnect the power and demonstrate the function of automatic power breaker. The secondary objective of the present invention is to provide a safety connector with power breaker, comprising a concave track each on both sides of the groove in the base and an arc opening to form a circumference with the semicircular openings at the section of the two longitudinal boards of the socket, and a fixed switch being used to balance the support axle to facilitate the control over the switching function.

Another objective of the present invention is to provide a safety connector with power breaker, comprising two aslant wings coupled to both ends of the conductive board for being slid and embedded into the square groove at the bottom of the two longitudinal boards in order to fix the board into a position.

Another further objective of the present invention is to provide a safety connector with power breaker, comprising a protrusion on the surface of the groove in the opposite direction to the arc surface of the latch which is coupled to the bottom of the socket in order to integrally couple the safety connector.

### BRIEF DESCRIPTION OF THE DRAWINGS

FIG. 1 is an illustrative diagram of the safety connector with power breaker according to the present invention;

FIG. 2 is a perspective diagram of the components of the safety connector with power breaker according to the present invention;

FIG. 3 is a cross-sectional diagram of the assembled structure according to the present invention;

FIG. 4 is an illustrative diagram of the automatic switch being latched to a fixed position on the conductive board according to the present invention;

FIG. 5 is an illustrative diagram of the assembled structure of the automatic switch being latched to the conductive plate latching base;

FIG. 6 is an illustrative diagram of the assembly according to the preferred embodiment of the present invention; and

FIG. 7 is an illustrative diagram illustrating how the components work according to the present invention.

### DELTAILED DESCRIPTION OF THE PREFERRED EMBODIMENT

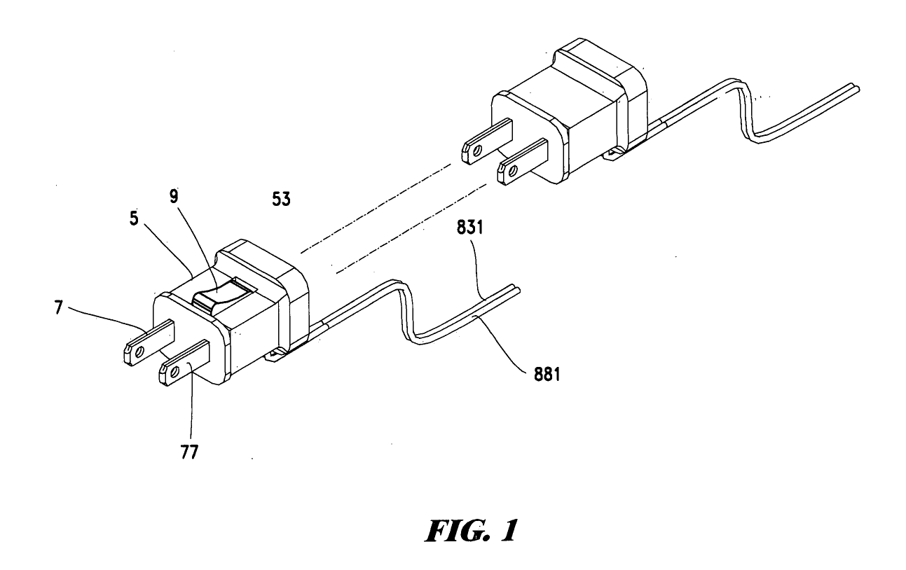

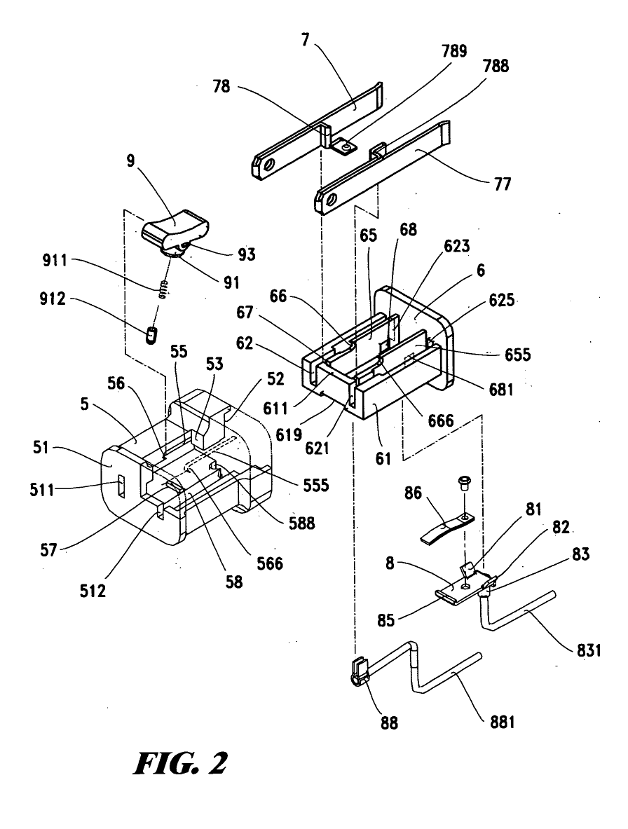

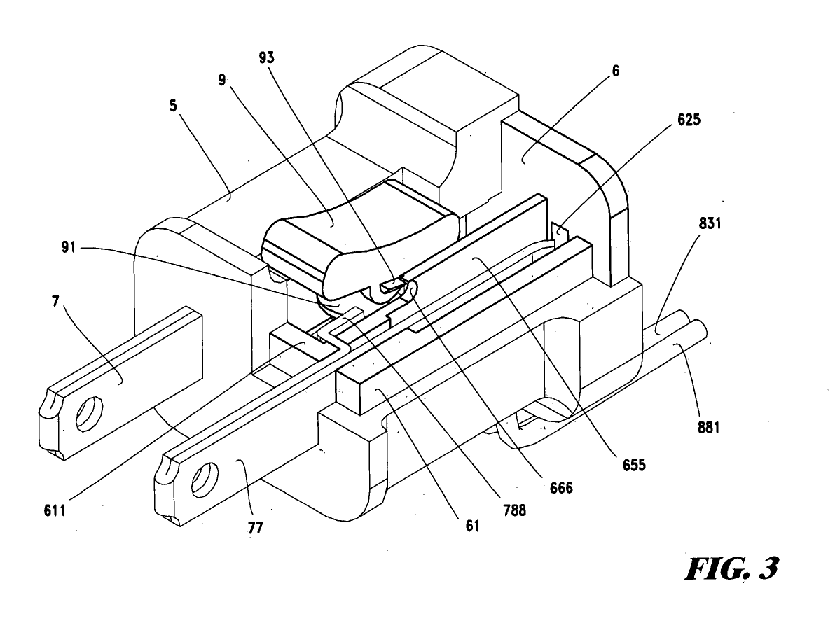

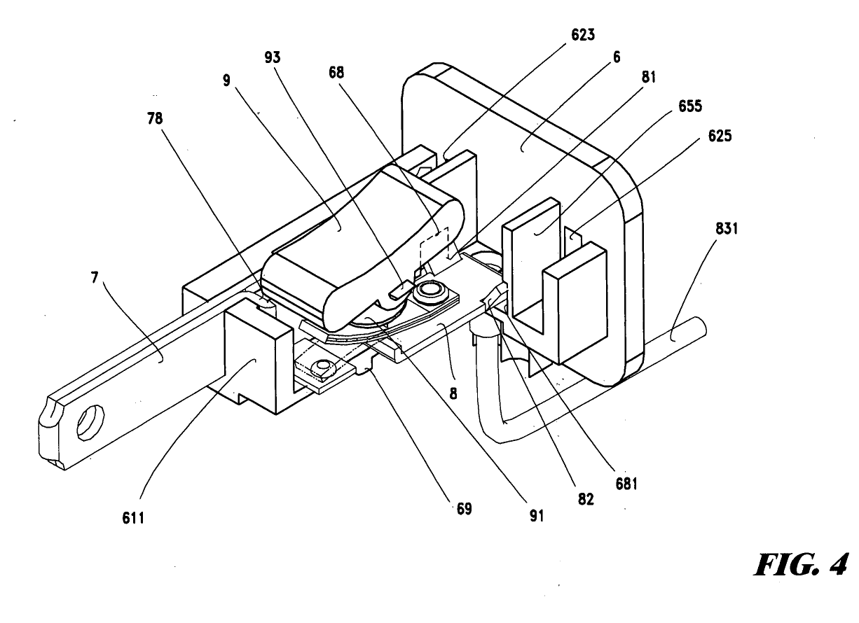

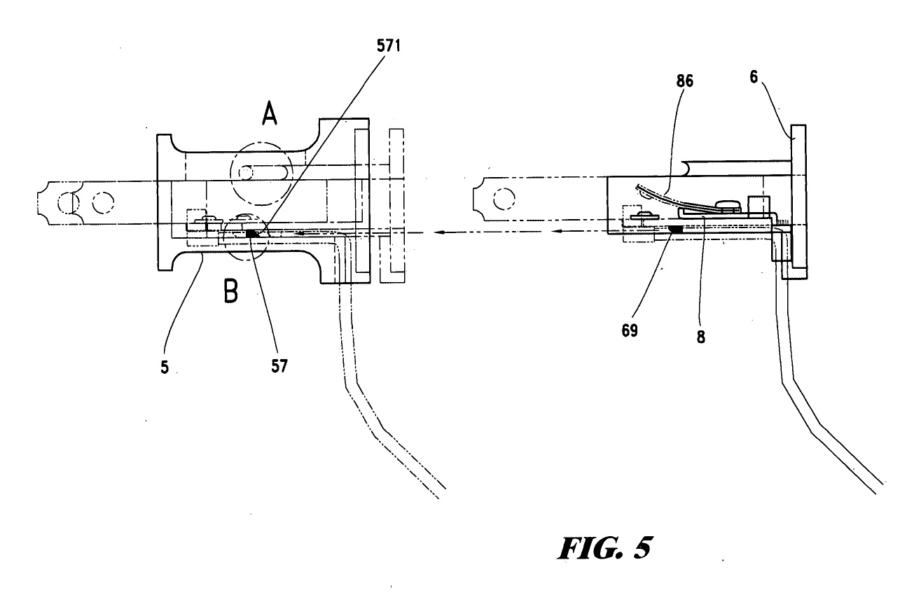

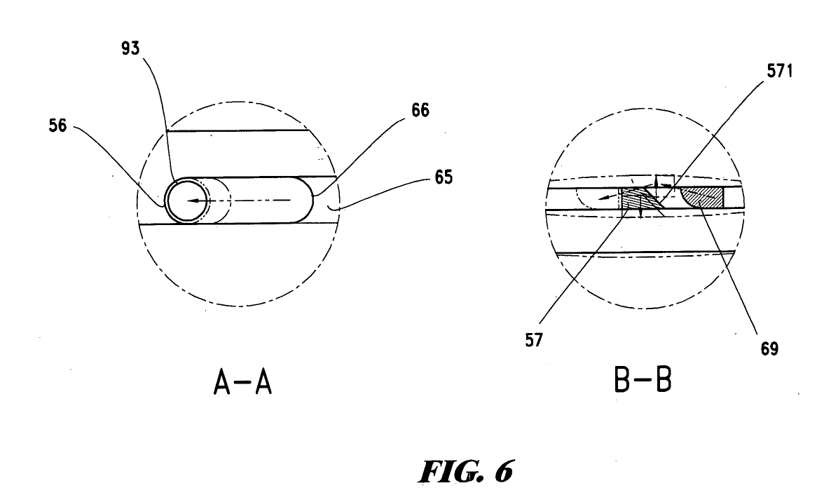

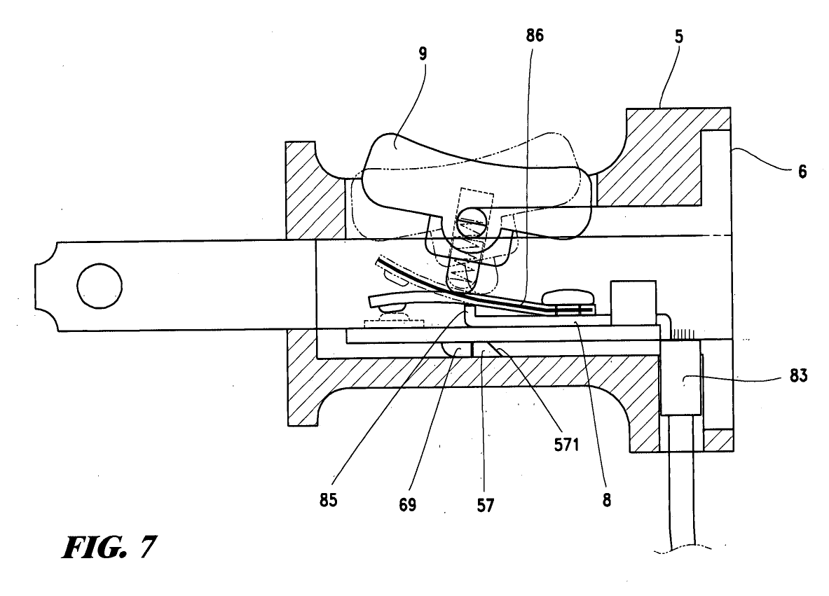

Please refer to FIGS. 1 to 7 for the safety connector with power breaker in accordance with this invention, comprising a base, a connector, a terminal plate, a conductive board, a switch, and an electric wire. The base of this invention is a square frame 5, forming a closed wall 51 in the front section of the base, and comprising two through holes 511, 512 disposed on the two terminal plates at the ends of the board. A groove opening 52 disposed on the rear end of the said base for receiving the corresponding socket, a coupling hole 53 disposed on the top of the frame of the base, two concave tracks 55, 555 disposed in the inner groove of the groove opening, and the bottom of the track being substantially a semicircular opening 56, 566. A conical surface 571 disposed in the opposite direction to the front of a protrusion 57 which is coupled to the bottom of the groove of the said base, and a groove 58 being defined next to the protrusion for accommodating the electric wire and two symmetric indentations 588 being formed on both ends of the groove for securing the electric wire and preventing it from loosening or falling apart.

The socket comprises a plugging board 6 coupled to a base block 61, an insert hole 52, 621 being disposed on a front board 611 corresponsive to two through holes 623, 625 on both sides of the plugging board. Two longitudinal boards 65, 655 being integrally extended to the rear end of the plugging board, and the section with an appropriate distance between the two boards forming a semicircular opening 66, 666, and a gap 67 being kept between the end of the board and the front board 611 to fix the terminal plate into a position. Two square grooves 68, 681 being disposed corresponsive to each other on both longitudinal boards, and a sliding track 619 being disposed at the bottom of the base, and a latch 69 coupled to the protrusion being disposed at the middle of the sliding track.

The terminal plate comprises two long board components 7, 77, each being bent to 180° at the middle section of the merged boards, and a corner 78 of the bent section of one terminal plate for embedding into the groove. The bent section of the other terminal plate is a substantially S-shaped board for hooking into the gap and coupling to the opening of a duct to secure the terminal plate into a fixed position.

The conductive plate, comprising two wing plates 81, 82 integrally disposed aslant to the rear side of a flat board 8, and a tubular section 83 disposed at the rear end of the board for clipping the electric wire 831. An arc board 85 tilted in front of the said board body such that the holes on the conductive plate 86 precisely running across the arc board to couple the end of the conductive plate with another end of the terminal plate and further provide the rear end of the S-shaped board for the electric wire 881, which is clipped in the diameter of the conductive pipe 88.

The switch is a T-shaped block 9 having a hole at the lower section 91 for plugging a bouncing component 911, and a contractible valve 912 coupled to the rear end of the bouncing component for being plugged into the hole. A support axle 93 passing through a hole on one side of the said T-shaped block to the hole on the opposite side such that both axial ends of the support axle are installed into the base and the two semicircular openings of the socket to constitute a balance direction of a circumference to facilitate the semicircular component of the contractible value of the lower section normally attaching onto the conductive board. The said conductive board lifts the arc board 85 at the middle section for switching its movement at the front and back sections, and the conductive board will bounce off due to the high temperature coefficient to instantly disconnect the power and demonstrate the function of automatic power breaker.

The application of the socket according to this invention passes an electric wire at the tubular section 83 of the conductive board through the bottom of the socket slot, and gently presses the conductive board such that the wing plates aslant to both sides are embedded into the square grooves of the two longitudinal plates. Then using the conductive pipe 88 to clip the tubular section of the electric wire and passes its bottom through the hole of the base to plug the bent corner 78 of the terminal plate into the gap. An extended component 789 at the rear end is coupled to the base board such that the two longitudinal boards of the plugging board are aligned with and pushed into the two tracks 55, 555 inside the grooves of the base, so that the semicircular openings at both ends of the two boards and the corresponding semicircular openings 56, 566 at the bottom of the track jointly define the circumference and fix the T-shaped component of the support axle to form a balanced direction in order to facilitate the contractible valve surface 912 at the lower section of the switch to normally attach to the end of the conductive board. The conical surface 571 in the opposite direction of the protrusion of the groove of the base is used to gently push the arc surface in front of the latch 69 of the sliding track of the socket for the mutual connection as one piece. When the plugging board 6 is installed onto the frame of the base while the spherical component of the tubular section 83 at the rear end of the conductive pipe and the electric wire 881 clipped by the conductive pipe 88 are jointly latched into the groove 58 and the solid assembly of the two symmetric openings 588. Consequently, the electric energy will be overheated and overloaded. By means of the conductive board tilting the arc board 85, its middle section is set for the switch movement at both the front and rear sections, such that the conductive board will bounce off due to the high temperature coefficient to instantly disconnect the power and demonstrate the function of automatic power breaker.

This invention adopts a safety switch for the connector to prevent any accidents due to spark caused by electrical overload or overheat that jeopardize people's life or health.

While the present invention has been described in connection with what is considered the most practical and preferred embodiment, it is understood that the invention is not limited to the disclosed embodiments but is intended to cover various arrangements included within the spirit and scope of the broadest interpretation and equivalent arrangements.

1. A safety connector with power breaker, comprising:
a base, is a square frame and further comprising a closed board at its front, two through holes at the ends of the said closed board, and a groove opening corresponding to a socket at the rear end of the said base. There is a switch-coupling hole disposed on the top of the said frame, two tracks disposed at the groove opening and an arc radial opening at the bottom of the said track. The conical surface is disposed in the opposite direction before a protrusion coupled to the said base, and a corresponding opening each disposed on a concave wire groove next to the said protrusion and the end of the said groove;
a socket, is a plugging board coupled to a base block, a through hole each on both sides of the said plugging plate corresponding to the inserted hole of the said terminal plate reserved on the said board. Two longitudinal boards extended from the rear side of the said plugging board, a semicircular opening bent downward with an appropriate distance between the said two boards, and a gap being kept between the end of the said board and the said front board for fixing and embedding the corner of the said terminal plate into a position. Two square groove sections is disposed on the inner sides corresponding to the said two longitudinal boards, a sliding track disposed at the bottom of the base block, and there is a latch component for latching the middle section of the said sliding track with the said protrusion;
a terminal plate, comprising two long plate components, each being bent to 180° to merge with the middle section of the board surface, and the corner of the bent section of one terminal plate being embedded into the said gap. The bent section of the other terminal plate being a S-shaped board for hooking into the gap, and the conductive pipe opening being mounted to a fixed position;
a conductive board, is a flat plate and further comprising two integrally coupled aslant wing plates, and a tubular section is disposed at the rear end of the said board for clipping the electric wire. An arc board is tilted in front of the said board body for enabling the said conductive plate to precisely run across the rear end of the said plate and in contact with another terminal plate;
a switch, is a T-shaped component coupled to the lower section and having a hole for plugging a bouncing component. There is a contractible valve and a support axle passing through the hole on the T-Shaped component and the hole on the opposite side into the base and the socket formed by two semicircular openings to constitute a balanced direction. The said conductive board is tilting the said arc board for the switching movement at both front and rear sections. The conductive board will bounce off due to the high temperature coefficient to instantly disconnect the power and demonstrate the function of automatic power breaker.

2. The safety connector with power breaker of claim 1, wherein the said base on both sides of the groove, each having a concave track and semicircular opening forms a circumference with the semicircular opening on the section of the said two longitudinal boards of the said socket for fixing the said switch and balancing the said support axle to facilitate the control over the switching function.

3. The safety connector with power breaker of claim 1, wherein the said conductive board comprises two aslant wing plates coupled to the end of the said conductive board for pushing a stopper in the same direction into the square groove section disposed on the bottom of the said two longitudinal boards for the support and mounting effects.

4. The safety connector with power breaker of claim 1, further comprising a protrusion disposed on the surface of the groove of the said base for integrally latching with the arc surface at the bottom of the said socket in the opposite direction.
